(19) United States
(12) Patent Application Publication
(10) Pub. No.: US 2026/0332945 A1
(43) Pub. Date: Oct. 22, 2026

(54) AUDIO VISUAL SYSTEMS WITH MAGNETICALLY ATTACHABLE AND ROTATABLE ADJUSTABLE AUDIO DEVICES

(71) Applicant: VIZIO, INC., Irvine, CA (US)

(72) Inventors: Glen Gihong Kim, Anaheim, CA (US); W. Leo Hoarty, Morgan Hill, CA (US)

(21) Appl. No.: 19/652,662

(22) Filed: Apr. 20, 2026

Related U.S. Application Data
(60) Provisional application No. 63/791,775, filed on Apr. 21, 2025.

(51) Int. Cl. H04R 1/32; H04R 1/02

(52) U.S. Cl. CPC H04R 1/323; H04R 1/026; H04R 1/028; H04R 2499/15

(57) ABSTRACT

Audio-visual systems comprise a video display and a soundbar attached to an upper or lower surface of the video display. Soundbars or portions thereof are rotatable to vary an angle between median axes of speaker drivers in the soundbars and a horizontal plane allowing for adjustment of speaker driver orientations relative to a viewer/listener based on the content being played by the speaker driver. Each speaker may be supported on an audio mounting system. Engagement of a motor-driven pinion gear on the soundbar and a rack gear attached to a panel attached to the video display, causes the panel attached to the soundbar to rotate about the hinge axis. In some implementations, the soundbar is defined by a series of speaker segments, each of which can be rotated relative to one another, and in certain variations, speaker drivers are rotatable relative to the speaker housings in which they are disposed.

### CROSS REFERENCE TO RELATED APPLICATIONS

This application claims the benefit of and priority to U.S. Provisional Patent Application No. 63/791,775, filed on Apr. 21, 2025, the contents of which are incorporated herein by reference in their entirety.

### TECHNICAL FIELD

This disclosure relates generally to securely and conveniently mounting certain consumer electronic devices such as soundbars to other devices such as flatscreen televisions such that the devices are easily mounted and their respective internal speakers are rotatable.

### BACKGROUND

A smart TV is an internet-connected television with an internal microprocessor unit that offers a range of online features, such as on-demand content from apps internally installed in the MCU of the smart TV which can access streaming services on the Internet, as well as the ability to connect other wireless devices to the smart television. However, due to their thin front-to back dimensions, flatscreen televisions generally do not come with significant internal audio speakers. Hence, a standalone speaker system, usually called a “soundbar”, has become a popular accessory to enhance the TV's audio output.

The mounting of such soundbars is typically done underneath or on top of the host flat screen TV after the TV is mounted on a wall; usually by using brackets and screws to secure the soundbar. Some manufacturers offer an easy to install soundbar that attaches to their brand of smart TVs, unusually underneath, without the need of tools. However, the choice of soundbar model is limited and only that manufacturer's products can use the mounting scheme. If a third-party brand of soundbar is desired, the mounting step requires tools and skills that not all prospective users will have, and the semi-permanent mounting of additional electronics to an interior wall which is usually undesirable to the average homeowner and not even an option for a renter.

Alternatively, soundbars are placed on a table in front of the TV, especially for home with entertainment systems and video game consoles. Though easy to install in this position where the soundbar simply sits on a tabletop, the soundbar is often blocked by a viewer sitting in front of the TV resulting in poor sound quality to other viewers. Additionally, in the tabletop position, the quality of surround sound program audio if often compromised regardless of seat arrangements.

It may be desirable to provide a soundbar that can be easily attached to and removed from a smart TV or other video monitor without the need for mechanical fasteners. In addition, it would be desirable to be able to automatically rotate some or all or the internal speakers of a soundbar. This would improve the ability to play different audio streams from a movie, TV show, sporting event, or the like through differently oriented speakers to alter the spatial distribution of the sound directed at and around the viewer/listener. Thus, a need has arisen for an audio mounting system that addresses the foregoing issues.

### SUMMARY

In accordance with a first aspect of the present disclosure, an audio visual system is provided which comprises a video display having a video display housing, wherein the video display housing has an upper surface and a lower surface spaced apart along a video display height axis. The audio visual system also includes an audio system that includes a speaker comprising at least one speaker driver in a speaker housing. The speaker housing has lower surface, and the at least one speaker driver has a median axis, wherein the lower surface of the speaker housing is magnetically attached to the upper surface of the video display such that a non-orthogonal angle is defined between the median axis and a horizontal plane.

In accordance with a second aspect of the present disclosure, an audio visual system is provided which comprises a video display having an upper surface and a lower surface, and an adjustable speaker mounting system magnetically attached to a video display selected surface from among the upper surface and the lower surface of the video display, the adjustable speaker mounting system having a speaker engagement support that is rotatable relative to the video display selected surface.

In accordance with a third aspect of the present disclosure, a speaker system is provided which comprises and audio system having a speaker that comprises at least one speaker driver disposed in a speaker housing. An adjustable speaker mounting system is provided and comprises a first member hingedly connected to a second member such that the first and second members are rotatable relative to one another about an axis of rotation. The speaker housing is removably attachable to the first member such that when the speaker housing is attached to the first member, an angle defined between a median axis of the at least one speaker driver and a plane parallel to the second member can be adjusted by rotating the first member relative to the second member.

In accordance with a fourth aspect of the present disclosure, a method of playing audio visual content is provided. The method comprises providing a soundbar comprising a plurality of speakers. Each speaker comprises a respective at least one speaker driver disposed in a respective speaker housing, wherein the soundbar is attached to one selected from a video display upper surface or a video display lower surface. The method comprises transmitting different audio content to each of the speakers in the plurality of speakers. The method further comprises automatically rotating a first speaker driver from among the speaker drivers in the plurality of speakers relative to the respective speaker housing in which the first speaker driver is disposed, and automatically rotating a second speaker driver from among the speaker drivers in the plurality of speakers relative to the first speaker driver based on audio content received by the first and second speaker drivers.

### BRIEF DESCRIPTION OF THE DRAWINGS

Features, embodiments, and advantages of the present disclosure are better understood when the following Detailed Description is read with reference to the accompanying drawings;

FIG. 1A-1B are side elevational views of an audio-visual system comprising a soundbar magnetically attached to an upper surface of a video display;

FIG. 2A is a schematic view depicting the path of soundwaves transmitted from the audio-visual system of FIGS. 1A-1B to a viewer/listener;

FIG. 2B is a schematic view of the path of soundwaves transmitted from a soundbar magnetically attached to a lower surface of a video display to a viewer/listener;

FIGS. 3A-3B depict a television with a support shelf angled downwardly and rearwardly of the display screen of a video display both without and with a soundbar installed on the support shelf, respectively;

FIG. 4 is a front elevation view of a three-segment soundbar attached to an adjustable speaker mounting system that is attachable to an upper surface of a video display, wherein the soundbar segments are independently rotatable relative to a horizontal plane and to one another;

FIGS. 5A-5C depict an audio visual system in which the multi-segment soundbar of FIG. 4 is attached to the video display of FIGS. 1A-1B, showing an end speaker segment in three different rotational orientations relative to a horizontal plane;

FIG. 6 is a close-up side elevation view of an end speaker segment of the audio system of FIG. 4 attached to a video display, illustrating the magnetic attachment of the soundbar to an upper surface of a television and an adjustable speaker mounting system comprising a hinged pair of panels used to rotate the soundbar relative to a horizontal plane;

FIG. 7 is a front elevation view of a five-segment soundbar attached to an adjustable speaker mounting system that is attachable to an upper surface of a video display, wherein the soundbar segments are independently rotatable relative to a horizontal plane and to one another and in which the speaker drivers are rotatable relative to their respective speaker housings;

FIG. 8 depicts a perspective view of an audio visual system with the five-segment soundbar of FIG. 7 in which the speaker segments are in different rotational positions relative to one another and relative to a horizontal plane, and in which the end speaker segment drivers are rotated relative to a plane defined by the segment's thickness and height axes;

FIGS. 9A-9B depict a top plan view of the speaker segments of the audio system of FIG. 7 in which different segments of the soundbar are in the rotated orientations of FIG. 7 and in which certain of the speaker drivers are rotated about an axis parallel to their respective speaker segment's height axis; and

FIGS. 10A-10E depict the corresponding cross-sectional views identified in FIGS. 9A-9B with the multi-segment soundbar installed on a video display.

### DETAILED DESCRIPTION

Described herein are audio visual systems that attach speakers to a video display via magnetic attachment. In the same or other examples, the speakers define a soundbar and comprise speaker drivers that are rotatable about one or more axes. Multiple speakers may also be positioned adjacent one another to collectively define a multi-segmented soundbar in which the segments are rotatable relative to one another. In certain examples, the rotation is motor-driven and may be carried out in response to the transmission of certain audio content on the channel to which a speaker segment is operatively connected. For example, audio signals from a source of audio visual content may be decoded to determine an angle of orientation of a speaker operatively connected to the channel.

In certain examples, the magnetic soundbar attachment systems described herein provide a secure and tool-free installation process.

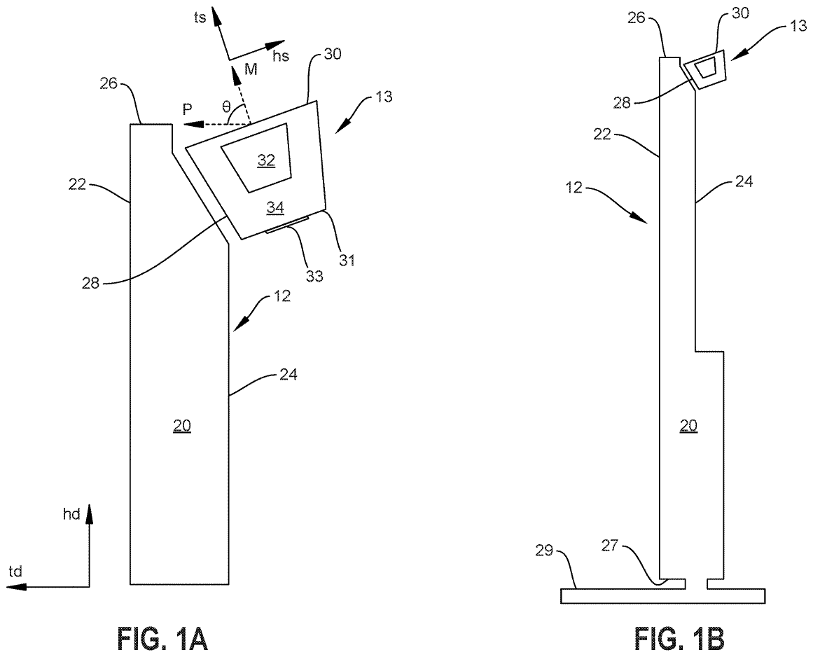

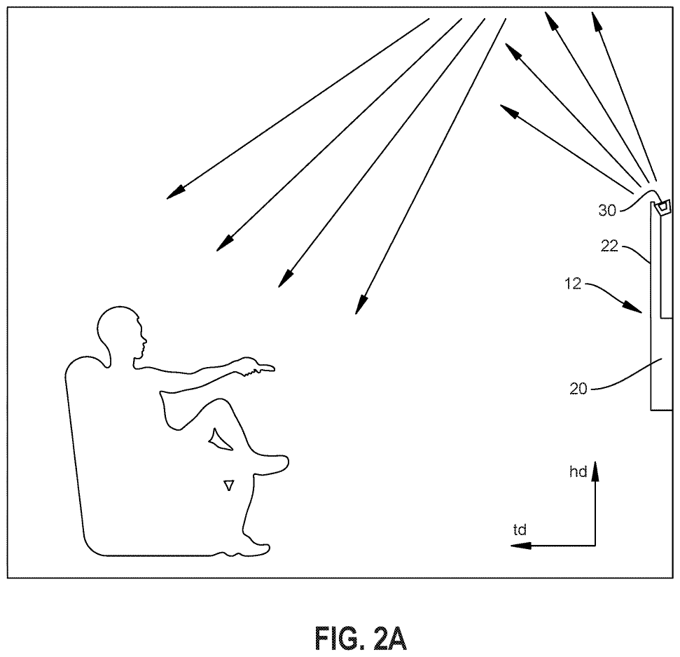

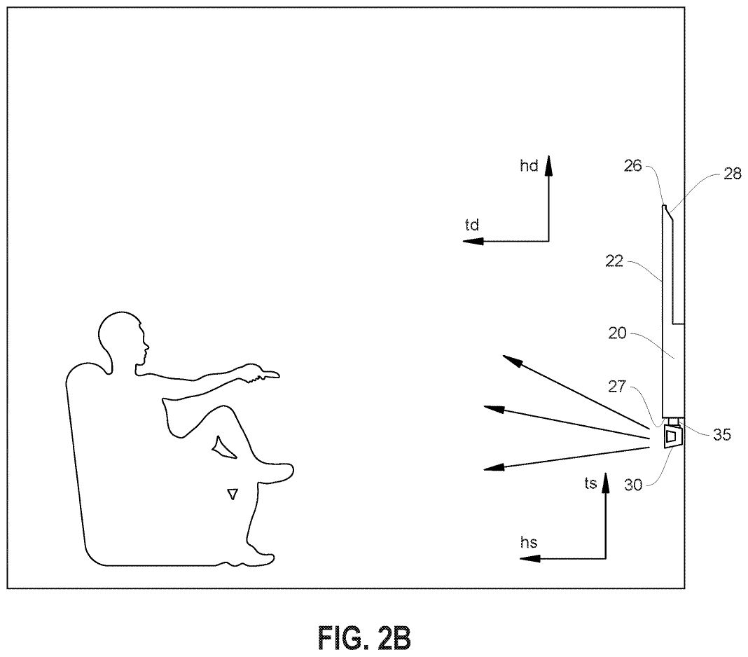

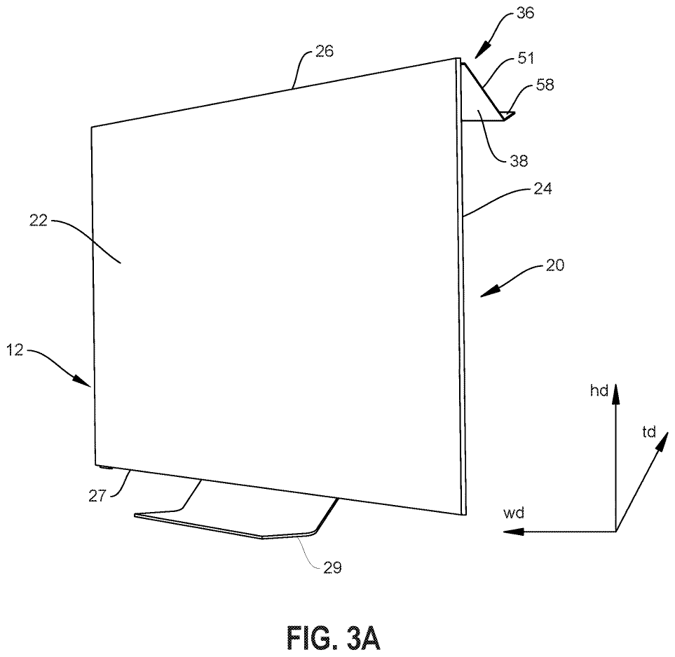

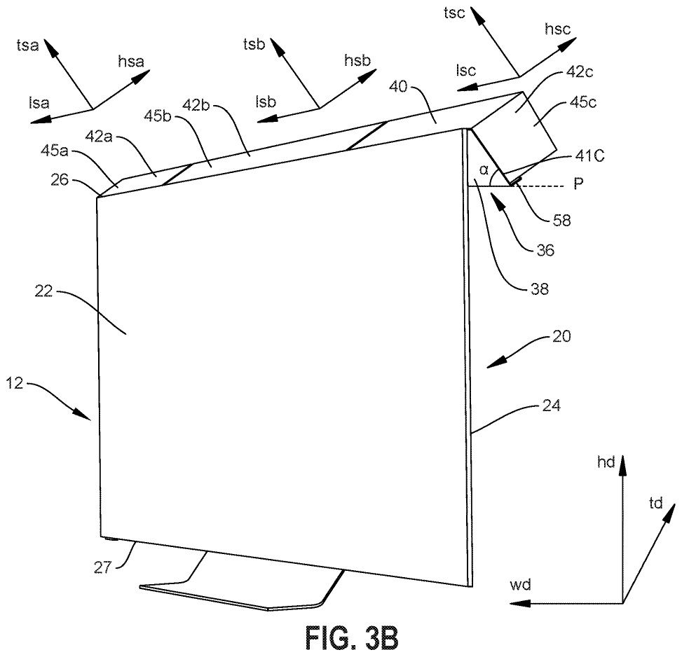

Referring to FIGS. 1A-2A, an audio visual system 12 is depicted which comprises a video display 20 and an audio system 13 that comprises a speaker 30, or, in other examples, a soundbar comprising a plurality of speakers. Video display 20 comprises a display surface 22 which is the surface on which video images are displayed to a viewer and also comprises a rear surface 24 that is spaced apart from the display surface 22 along a display thickness axis t_{d}. A video display upper surface 26 is spaced apart from a video display lower surface 27 along a display height axis h_{d}. video display lower surface 27 is connected base 29 such that video display lower surface 27 is positioned between base 29 and video display upper surface 26 along the display height axis h_{d}. As best seen in FIGS. 3A-B, display 20 also has a width defining width axis w_{d} that is perpendicular to the thickness axis t_{d} and height axis, t_{d}, respectively.

Referring again to FIG. 1A, speaker 30 includes speaker driver 32 and may include additional drivers. Speaker 30 has a thickness axis tₛ, a height axis hₛ, and a length axis lₛ (going perpendicular into the page and not visible in FIG. 1A). For any specific speaker or speaker segment, its axes are defined relative to particular dimensions of a speaker and are therefore not fixed in space, but rather, are fixed relative to those dimensions on the speaker or segment even if is rotated, translated etc. Speaker driver 32 has a median axis M, which in FIG. 1A is parallel to the speaker thickness axis tₛ. In FIGS. 1A-2A, speaker 30 is positioned so that the direction of sound travel along median driver axis M is upward toward the ceiling relative to a horizontal plane P that intersects the median axis at surface of the speaker housing 34. As explained further below, the angle of inclination θ may be referred to as an “upfiring angle” and is preferably no less than 30 degrees, more preferably no less than 40 degrees, and still more preferably no less than 45 degrees upward relative to horizontal plane P. In FIGS. 1A-2A the upfiring angle θ is about 45 degrees or π/4 radians.

Speaker 30 comprises a housing 34 that houses speaker driver 32. Housing 34 includes a lower surface 31 that is magnetically attached to an upper speaker engagement surface 28 of video display 20. The upper speaker engagement surface 28 of display 20 is located beneath the video display upper surface 26 along the video display height axis h_{d} and slopes upward when moving along the thickness axis t_{d} in a direction away from rear surface 24 and toward display surface 22.

The magnetic attachment of lower speaker housing surface 31 and upper speaker engagement surface 28 of video display 20 may be configured in a number of different ways. In FIG. 1A a magnet 33 is physically attached (e.g., by glue or fasteners) to lower speaker housing surface 31 and is of opposite magnetic polarity to upper speaker engagement surface 28 of video display 20. In one variant, magnet 33 may be directly attached to lower housing surface 31 of speaker 30 or may be embedded in a rubber layer that is attached to lower housing surface 31 of speaker 30, and speaker engagement surface 28 of video display 20 may comprise a suitably magnetic metal of opposite polarity. In another variant, magnet 33 may be attached to upper speaker engagement surface 28 of video display 20 or embedded in a rubber layer attached to upper speaker engagement surface 28 of video display 20, and lower housing surface 31 of speaker housing 34 may comprise a suitably magnetic metal of opposite polarity.

As indicated above, speaker 30 is oriented so that its median axis M and its thickness axis tₛ define an upward firing angle (upfiring angle θ) relative to horizontal plane P. As shown in FIG. 2A, this allows speaker 30 to project sound upward toward a ceiling such that the soundwaves are reflected off of the ceiling toward the viewer/listener so that from the viewer/listener's perspective, it is as if the sound is transmitted from a speaker attached to the ceiling. As suggested in FIG. 2A, in one use case, the video display 20 is wall-mounted and spaced apart from the viewer/listener in a direction along the video display thickness axis t_{d}. The positioning of video display 20 relative to viewer/listener and the value and direction of upfiring angle θ of the speaker driver 32 is such that a vertical component of the median axis M of speaker driver 32 intersects the ceiling at a location along the display thickness axis t_{d} that is between the viewer/listener and the video display 20 along the thickness axis t_{d}. In the specific example of FIG. 2A, speaker 30 is spaced apart vertically above the viewer/listener's head along the direction of the video display height axis h_{d}. The orientation of FIG. 2A is particularly beneficial when speaker 30 is used to play upfiring audio content that is intended to sound like it emanates from above the viewer/listener's head.

One benefit of positioning speaker 30 at the top and rear of video display 20 is that it is less likely to be blocked by viewers sitting in front of display 20, and will thus, provide clearer sound to a greater number of viewer/listeners. This in turn provides more uniform and clearer sound dissipation in the room in which the audio-visual system 12 is located. Also, locating the speaker 30 in such a position allows for more precise angling of speakers intended for use with upfiring audio content, such as Dolby ATMOS, or similar surround-sound effects.

In FIG. 2B video display 20 is wall mounted. In this case speaker 30 is positioned beneath video display 20 along the display height axis h_{d}. A speaker mount 35 with a speaker engagement surface 37 (not visible) is attached to lower surface 27 of video display 20. Speaker engagement surface 37 may be magnetically attached to an upper surface of speaker housing 34. In other examples, the “upper surface” of the speaker housing 34 is preferably the same surface of the speaker 30 as the lower surface 31 shown in FIG. 1A, i.e., in FIG. 2B the speaker 30 is flipped upside down relative to FIG. 2A. In the example of FIG. 2B speaker 30 is spaced apart from the viewer/listener in a direction along the video display thickness axis t_{d} and is positioned below the ears of the viewer/listener in a direction along the height axis h_{d} of the video display 20. However, in FIG. 2B, speaker 30 is not mounted such that the median axis M of driver 32 is angled upward relative to horizontal plane. Rather, the median axis M is generally parallel to the horizontal plane (i.e., θ=0). Thus, the orientation of FIG. 2B is not preferred for upfiring content. In the example of FIG. 2B, the magnetic force between speaker 30 and the lower speaker engagement surface 37 is preferably larger than the magnetic force between speaker 30 and speaker engagement surface 28 of FIG. 1A because the net gravitational force on speaker 30 in FIG. 2B will be greater than the net gravitational force on speaker 30 in FIG. 2A as in the latter case the speaker engagement surface 28 will exert a force against the speaker 30 with a vertically upward component.

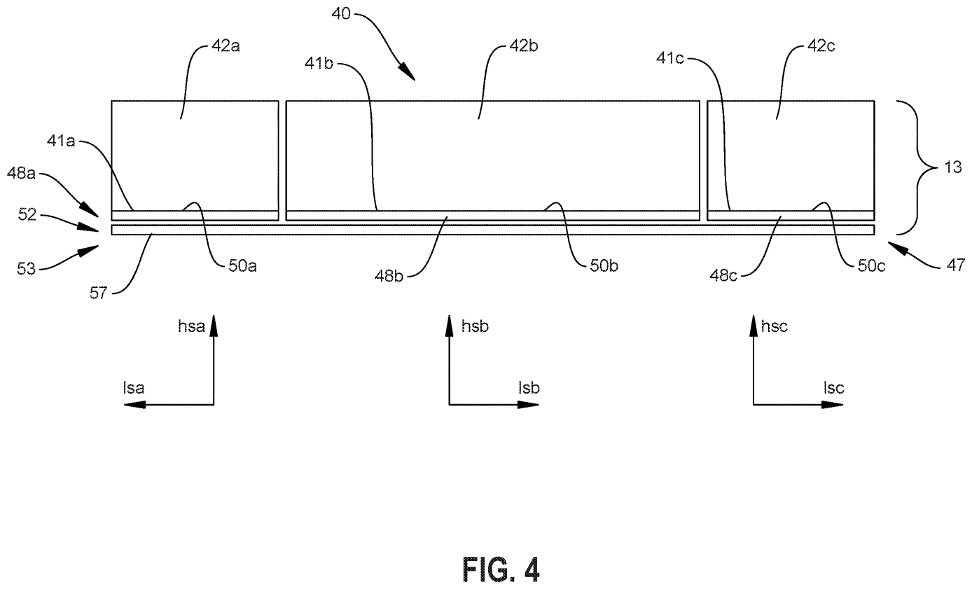

FIGS. 3A-3B depict another example of an audio-visual system. In this example, video display 20 has an audio system support shelf 36 attached to an speaker engagement surface 28 (not visible) of video display 20. Support shelf 36 comprises a first panel 38, with upper surface 51 and a rear support wall 58. FIG. 3A shows the audio visual system 12 without audio system 13 installed. In FIG. 3B a multi-segment soundbar 40 is attached to support shelf 36, preferably by magnetic attraction. Multi-segment soundbar 40 comprises three speaker segments 42a, 42b, and 42c which are arranged along the width axis w_{d} of the video display 20. In a variation further described with respect to FIGS. 4-6, segments 42a, 42b, and 42c may be rotatable relative to one another, and each speaker segment may be characterized by its own set of axes. One benefit of using both magnetic attraction and support shelf 36 with support wall 58 is that the shelf 36 maintains the segments 42a-c in a tilted condition and supports the segments 42a-42c against the force of gravity while the magnetic attraction provided by suitably sized and placed magnets reduces the propensity of speaker segments 42a-c to slide around on the upper surface 51 of support shelf 36. Thus, the combination of magnetic and physical/mechanical support provides more stable positioning of speaker segments 42a-c relative to display 20.

In one example, support shelf 36 is made of steel and attracts magnets embedded in a bottom surface of the housing of speaker segments 42a-c. In other examples, support shelf 36 is plastic or otherwise non-magnetic but has embedded magnets with a polarity opposite of those embedded in a bottom surface of the speaker segment 42a-42c housings.

In FIG. 3B speaker segment 42c has a speaker thickness axis t_{sc}, a speaker height axis h_{sc} and a speaker length axis lsc. The other speaker segments 42a and 42b have their own respective axes, and in FIG. 3B, the respective speaker segment thickness axes tₛₐ, t_{sb}, and t_{sc} are all parallel to one another, the speaker segment height axes hₛₐ, h_{sb}, and h_{sc} are all parallel to one another, and the respective speaker segment length axes lₛₐ, l_{sb}, and l_{sc} are all parallel to one another.

Speaker segments 42a-42c are configured to receive audio signals from a common source, but in some cases on separate channels supported by the audio source (e.g., an amplifier that amplifies audio signals received from a playback device, such as a CD player, tuner, DVD player, or smartphone) Each speaker segment 42a, 42b, and 42c comprises its own respective housing, 45a, 45b, or 45c, and may house one or more speaker drivers (not shown in FIGS. 3A-3B). In FIG. 3B each speaker segment 42a-42c is oriented to project sound in an upward direction along their respective speaker driver median axes (one of which is shown in FIG. 3B) relative to a horizontal plane as discussed with respect to FIG. 1A (i.e., θ is positive). Relative to a horizontal plane intersecting the median axes Mₐ-M_{c} at the face of each speaker housing, the upfiring angle θ of each speaker segment 42 a-42c is no less than about 30 degrees, preferably no less than about 40 degrees, and still more preferably no less than about 45 degrees. The lower surfaces 41a-41c (only 41c is shown) of speaker housings 45a-45c are magnetically attached to upper surface 51 of support shelf first panel 38. The magnetic attachment may be configured as described above with respect to the magnetic attachment of lower surface 31 of speaker housing 34 in FIG. 1A to upper speaker engagement surface 28 of video display 20. In FIG. 3B support shelf 36 may be attached to upper surface 26 (not visible in FIGS. 3A-3B) of video display 20 by any suitable means, for example, screws or other mechanical fasteners. The first panel 38 of support shelf 36 slopes upward when moving in a direction from the rear surface 24 to front display surface 22 of video display 20 along thickness axis t_{d} of video display 20.

A rear support wall 58 is connected to first panel 38 and is spaced apart from upper surface 26 of video display 20 in a direction from the front display surface 22 toward the rear surface 24 of video display 20 along the video display thickness axis t_{d}. Rear support wall 58 is angled upward when moving from its point of connection to first panel 38 in a direction away from video display 20 along the thickness axis t_{d} of video display 20. Relative to a horizontal plane P that is tangent to the location of interconnection between first panel 38 and rear support wall 58, first panel 38 is angled upward at a non-orthogonal angle α that is no less than about 30 degrees, preferably no less than about 40 degrees, and still more preferably no less than about 45 degrees. These are also the angles at which the speaker segments 42a, 42b, and 42c are tilted upward relative to a horizontal plane. Both first panel 38 and rear support wall 58 exert a force on speaker segments 42a-42c with an upward component in the vertical direction and thus support the multi-segment soundbar 40 against the force of gravity.

In a variant of the audio visual system 12 of FIGS. 3A-3B, each speaker segment 42a-42c of soundbar 40 is preferably manually or automatically rotatable about an axis of rotation that is parallel to the video display 20 width axis w_{d} to vary the upfiring angle of the respective speaker segment 42a-42c. In accordance with the second variant, an adjustable speaker mounting system is provided and attached to first panel 38 of speaker support shelf 36 and includes a speaker engagement support that is rotatable relative to upper surface 26 of video display 20.

Referring to FIGS. 4-6, the foregoing variant of the audio visual system 12 of FIGS. 3A-3B is depicted. In FIG. 4 audio system 13 is shown in a front elevational view and comprises three-segment soundbar 40 attached to an adjustable speaker mounting system 47. Soundbar 40 comprises speaker segments 42a, 42b, and 42c. Adjustable speaker mounting system 47 comprises a video display engagement support panel 53 that is attached to speaker engagement support panels 48a, 48b, and 48c, each of which is attached to a respective one of speaker segments 42a, 42b, and 42c, for example, using mechanical fasteners. The speaker segments 42a-42c can each be characterized by respective length, height, and thickness axes. Speaker segment 42a has a length axis lₛₐ, a height axis hₛₐ, and a thickness axis tₛₐ. Speaker segment 42b has a length axis l_{sb}, a height axis h_{sb}, and a thickness axis t_{sb}. Speaker segment 42c has a length axis l_{sc}, a height axis h_{sc}, and a thickness axis t_{sc}. The axes are fixed relative to their respective speaker segments 42a-42c even as the speaker segment rotates. Each speaker segment 42a-42c has a corresponding housing 45a, 45b, and 45c. Although not visible in FIG. 4, speaker segment 42a has a speaker driver 46a with a median axis Mₐ, speaker segment 42b has two speaker drivers 46b₁ and 46b₂ with respective speaker median axes M_{b1} and M_{b2}, and speaker segment 42c has a speaker driver 46c with a median axis M_{c}. The median axes Mₐ, M_{b1}, M_{b2}, and M_{c} are all perpendicular to the respective thickness axis tₛₐ, t_{sb}, t_{sc} of the corresponding speaker segment 42a, 42b, and 42c.

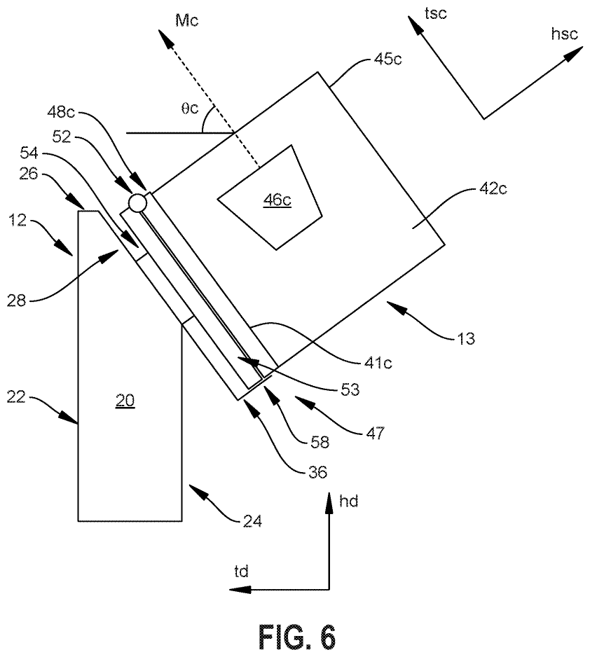

As best seen in FIG. 6, an upper portion of video display 20 includes upper surface 26 and a speaker engagement surface 28 that slopes downward and away from upper surface 26 when moving in a direction from front display surface 22 to rear surface 24 along the video display thickness axis t_{d}. An adjustable speaker mounting system 47 (FIGS. 4 and 6) is provided which is mountable to speaker engagement surface 28 of video display 20 or, as is depicted, to support shelf 36, which is mounted to upper speaker engagement surface 28. Adjustable speaker mounting system 47 is preferably magnetically attached to upper surface 51 of first panel 38 of support shelf 36. As best seen in FIG. 4, adjustable speaker mounting system 47 comprises a video display engagement support panel 53 that extends beneath each speaker segment 42a-42c along the width axis w_{d} of video display 20. The video display engagement support panel 53 is a common support panel used for all three segments 42a-42c. However, in another implementation, each speaker segment could have its own video display engagement support. In the example of FIG. 6, a magnet 54 is fixedly attached to a lower surface 57 of video display engagement support panel 53 and has a polarity opposite to that of first member 38 of support shelf 36. In another implementation, lower surface 57 of video display engagement support panel 53 is magnetic and has a polarity opposite to that of magnet 54, which is fixedly attached to upper surface 51 of first member 38 of support shelf 36.

As mentioned above, each speaker segment 42a-42c is rotatable about an axis parallel to the width axis w_{d} of video display 20. Each speaker segment 42a-42c has a respective lower housing surface 41a-41c that is attached to a respective upper surface 50a-50c of a respective speaker engagement support panel 48a-48c that is connected to video display engagement support panel 53 via a common hinge 52, or in some implementations, a respective hinge. Hinge 52 has a length along the width axis w_{d} of video display 20 that defines an axis of rotation about which each speaker segment 42a-42c can rotate to alter the upfiring angles θ (defined below) of its respective speaker driver 46a-46c median axes Mₐ, M_{b1}, M_{b2}, M_{c} relative to a horizontal plane P. Hinge 52 is located at or slightly vertically above upper surface 26 of video display 20 along the video display height axis h and is located between upper surface 26 and rear surface 24 of video display 20 along the video display thickness axis t_{d}.

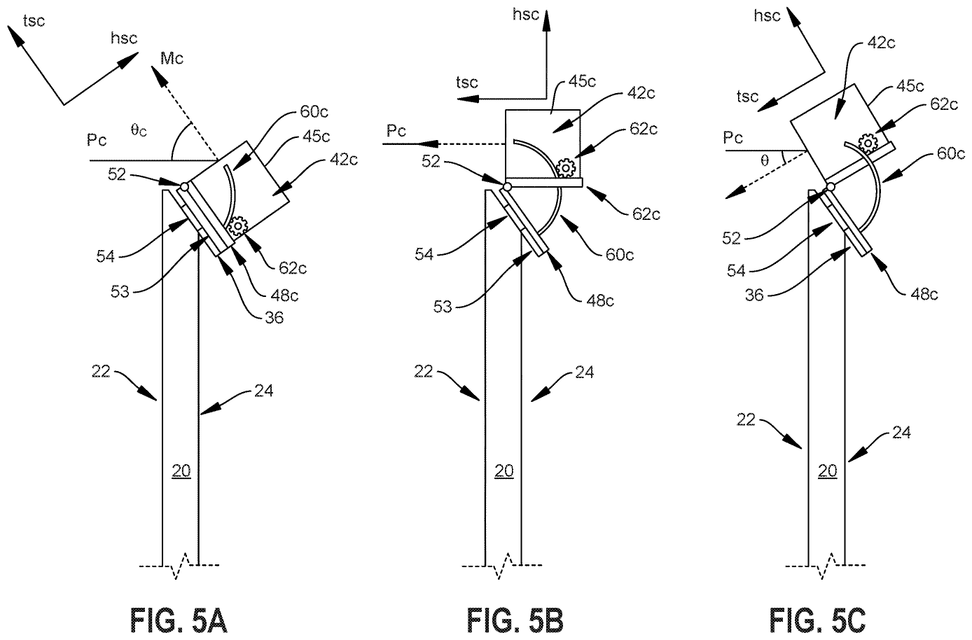

As shown in FIGS. 5A and 6, in a “rest” or unrotated configuration, speaker segment 42c is oriented such that the median axis M_{c} of speaker driver 46c and the thickness axis t_{sc} of speaker segment 42c are oriented at a positive angle θ_{c} relative to horizontal plane P. Note that the horizontal plane P is not a fixed plane. Rather it is a plane that intersects the median axis M_{c} at a location Q where the median axis intersects the front face on the outside of the speaker housing 45c. It can also be characterized as a plane parallel to the ground which intersects the median axis at the front face of the speaker housing. The angle θ defined by horizontal plane P and a speaker driver 46a-46c median axis may be referred to as an “upfiring angle”. Because each speaker segment 42a-42c is rotatable relative to the others, each will have a respective upfiring angle θₐ θ_{b}, or θ_{c}. For any particular speaker driver 46a-46c, positive upfiring angle θ values indicate that the driver median axis angles upward from its point of intersection Q with one of the speaker housings 45a-45c relative to a horizonal plane P at the location of intersection Q between the housing 45a-45c and that speaker driver's median axis M. This is illustrated in FIGS. 5A and 6 with respect to the speaker driver 46c median axis M_{c} and it point of intersection Q_{c} with the front face of housing 45c. Thus, for any given speaker driver 46a-46c, its corresponding upfiring angle θₐ, θ_{b}, or θ_{c} will be the angle defined between its median axis Mₐ, M_{b1,} M_{b2}, M_{c} and a respective horizontal plane Pₐ, P_{b}, P_{c} that intersects a fixed location Qₐ, Q_{b}, Q_{c} on the front face of the speaker housing 45a-45c that houses the driver 46a-46c that has that axis. As the speaker engagement support panels 48a-48c rotate about the axis of rotation defined by hinge 42, the point of intersection Qₐ, Q_{b}, or Q_{c} between the median axis Mₐ, M_{b}, M_{c} of each speaker driver 46a, 46b, 46c and its respective speaker housing 45a-45c will traverse an arc, causing the median axis Mₐ, M_{b}, or M_{c} to both translate along the height and width axes of the video display 20 and rotate relative to horizontal plane P to adjust the value of the particular median axis'upfiring angle θₐ-θ_{c}.

As shown in FIGS. 5A and 6, the unrotated value of upfiring angle θ_{c} is preferably at least about +30 degrees, more preferably at least about +40 degrees, and still more preferably at least about +45 degrees. In preferred examples, each speaker segment 42a-42c is rotatable about the axis of rotation defined by hinge 52 to positive values of θ that are smaller than the rest or unrotated value of θ_{c} as well as to a “negative upfiring” angle in which the corresponding driver 46a-46c projects sound in a downward direction along median axis M_{c} relative to the corresponding horizontal plane P_{c}. As mentioned previously, the speaker engagement support panels 48a-48c may be manually or automatically rotated. In the case of manual rotation, a known method of providing indexed rotation of the speaker engagement support panels 48a-48c relative to video display engagement support panel 53 is preferably provided so that the desired degree of rotation can be maintained and so that the speaker engagement support panels 48a-48c can be returned to their rest or unrotated positions.

Referring to FIGS. 5A-5C audio visual system 12 is depicted in which the audio system 13 of FIG. 4 is installed on a video display 20. Thus, speaker segment support panels 48a-48c are rotatable about an axis of rotation defined by hinge 52. FIGS. 5A-5C show speaker segment 42c in three different orientations. In FIG. 5A, speaker segment 42c is in its rest or unrotated configuration as it is in FIG. 6. In this position the upfiring angle θ_{c} has a positive value. In FIG. 5B, speaker segment 42c is rotated about hinge 52 so that the median axis of speaker driver 46c (not shown in FIG. 5B) is substantially parallel or parallel to horizontal plane P. In this position, the upfiring angle θ_{c} has a value of 0. In FIG. 5C speaker segment 42 c is further rotated so that driver 46c median axis M_{c} is angled beneath horizontal plane P, i.e., the upfiring angle θ_{c} has a negative value.

In FIGS. 5A-5C soundbar 40 is configured as shown in FIGS. 3A-3B as is the adjustable speaker mounting system 47, except that adjustable speaker mounting system 47 provides automatic rotation of the speaker segments 42a-42c. More specifically, audio system 13 includes a plurality of first gears, each of which corresponds to a respective one of the speaker segments 42a-42c. A front elevation view (i.e. along the respective thickness axes tₐ, t_{b}, t_{c}, of each soundbar speaker segment 42ₐ, 42_{b}, 42_{c}) of the soundbar 40 mounted on the adjustable speaker mounting system 47 is shown in FIG. 4.

Each first gear engages a corresponding second gear corresponding to a respective soundbar segment 42a-42c. The second gear corresponding to a respective soundbar segment 42a-42c may be mounted on the corresponding soundbar segment housing 45a-45c or on the respective speaker engagement support panel 48a-48c on which the corresponding speaker segment 42a-42c sits. When one of them is actuated, the engagement of the two gears causes the corresponding speaker engagement support panel 48a-48c (and hence the attached speaker segment 42a-42c) to rotate about hinge 52 to in turn cause the speaker drivers 46a-46c to rotate and translate along with their respective median axes Mₐ-M_{c}. In the example of FIGS. 5A-5C, each speaker segment 42a-42c has an internal motor (not shown) that is operable to rotate an operatively connected respective pinion gear 62a-62c. The speaker housing 45a-45c does not translate, but rather, merely rotates about an axis defined by hinge 52. The motors are operable to rotate their respective pinion gear 62a-62c in a plane parallel to a plane defined by the height h_{d} and thickness t_{d} axes of the video display20.

Each pinion gear 62a-62c engages a respective rack gear 60a-60c that has a shape which defines the movement of the points of intersection Qₐ, Q_{b}, Q_{c} between the median axes Mₐ, M_{b}, M_{c} of the speaker drivers 46a-46c and the respective speaker housing 45a-45c when the pinion gear 62a-62c for the housing 45a-45c that houses the particular speaker driver 46a-46c rotatingly engages its corresponding rack gear 60a-60c. In FIGS. 5A-5C the rack gears 60a-60c have an arc shape, and thus, the median axes Mₐ, M_{b}, M_{c} and intersection points Qₐ, Q_{b}, Q_{c} traverse an arc path when the pinion gears 62a-62c engage their respective rack gear 60a-60c while rotating. Rack gears 60a-60c preferably have a cross-sectional profile when viewed along the speaker segment width axes wₛₐ-w_{sc} which defines an arc that subtends an angle of from about 80 degrees to about 110 degrees, preferably from about 85 degrees to about 105 degrees, and more preferably from about 88 degrees to about 92 degrees. The engagement causes each pinion gear 62 a-62c to travel all or part of the length of its corresponding rack gear 60a-60c. Each rack gear 60a-60c is connected to the video display engagement support panel 53 of the adjustable speaker mounting system 47. Each rack gear 60a-60c may extend through an opening of its corresponding speaker engagement support panel 48a-48c or may be spaced apart from the speaker engagement support panel 48a-48c along the video display width axis w_{d}. Because the pinion gears 62a-62c are connected to their respective speaker segments 42a-42c, as the pinion gears 62a-62c traverse their respective rack gears 60a-60c, the speaker segment 42a-42c will move in path defined by the rack gear 60a-60c shape, and the attachment of the speaker segment 42a-42c to its respective speaker engagement support panel 48a-48c will cause the speaker engagement support panel 48a-48c to rotate about the axis of rotation defined by hinge 52. Similarly using the horizontal position of speaker engagement support members 42a-42c (FIG. 5B) as a zero reference plane, speaker engagement support panels 48a-48c will rotate through an angular range of from about-55 degrees to about +55 degrees, preferably from about −50 degrees to about +50 degrees, and more preferably from about −45 degrees to about +45 degrees.

In an alternative implementation, the pinion gear 62a-62c motors may be mounted on their respective speaker engagement support panel 48a-48c. In another alternative implementation, each pinion gear may be mounted on the video display engagement support panel 53, and each rack gear 60a-60c may be mounted on its corresponding speaker housing 45a-45c or its corresponding speaker engagement support panel 48a-48c and sized so that the rotation of the pinion gear 62a-62c and its engagement with its corresponding rack gear causes the rack gear 60a-60c and for the affected support panel 48a-48c to move relative to the video display engagement support panel 53.

In certain implementations, the respective drivers 46a-46c of speaker segments 42a-42c are operatively connected to a channel of an audio source. The channels may receive the same or different content, and the content may vary as to its intended spatial orientation relative to a viewer/listener. In certain examples, one of the channels may communicate sounds that are intended to come from above the viewer/listener's head. A scene that includes airplanes for example may include airplane sounds that are intended to be heard as if they emanated from above the viewer/listener's head. So, in one example, the center speaker segment 42b may remain in its rest or neutral position in which the upfiring angle θ is positive—as is illustrated for soundbar speaker segment 42c in FIG. 5A—and has a value that causes the sound it transmits to reflect off of the ceiling and down toward the viewer/listener, as illustrated in FIG. 2A. At the same time, end speaker segments 42a and 42c may rotate into the position shown for speaker segment 42c in FIG. 5B in which the upfiring angle θ_{c} is about zero or into the position shown in FIG. 5C in which the upfiring angle θ_{c} has a negative value.

In accordance with certain examples of audio visual systems described herein, a speaker orientation controller may be provided and may output orientation control signals to the motors (not shown) that control the rotation of the pinion gears 62a-62c. A user control may be provided which allows the user to input a setpoint for a desired upfiring angle θₐ, θ_{b}, θ_{c} for any of the speaker segments 42a-42c, a well as for any other parameter(s) that corresponds to the upfiring angle θ, and the controller may output a control signal that causes the corresponding pinion gear(s) to rotate to a corresponding degree. Suitable motors include known servo motors and stepper motors. The extent of rotation of any of the pinion gears 62a-62c that corresponds to a desired upfiring angle θa, θb, θc will depend on the diameter of the pinion gear, the size of the pinion gear teeth, the size of the corresponding rack gear 60a-60c teeth, and the linear length and shape of the corresponding rack gear 60a-60c.

The user control may be mounted on some part of the audio visual system 12 and/or may comprise a remote control that transmits wireless control signals to an orientation controller that is operatively connected to the motors (not shown) for each speaker segment 42a-42c. Also, the orientation controller may receive an orientation set point from another controller that determines a desired value of the upfiring angle θₐ, θ_{b}, or θ_{c} based on content meta data associated with audio signals and/or based on room geometry data about the room in which the audio visual system 12 is located. The encoding and decoding of audio source signals into channel-specific content that may be used to set or adjust the value of the upfiring angle θₐ, θₐ, θₐ for particular speaker segment 42a-42c as well as the use of controllers to adjust a degree of speaker driver rotation is described in U.S. Pat. No. 11,095,976, which is assigned to the assignee of the present application and the entirety of which is incorporated by reference herein. Thus, in one exemplary implementation involving programs with upfiring audio content, such as Dolby ATMOS®, the speaker segment 42a-42c that is connected to the channel receiving such content will be maintained in an upfiring position such as is shown in FIG. 5A or to another upfiring angle between the angles depicted in FIGS. 5A and 5B.

The speaker segments 42a-42c and adjustable speaker mounting system 47 may be collectively supplied as an audio visual system 12 that includes video display 20 in either an attached or unattached configuration. Alternatively, audio system 13—comprising adjustable speaker mounting system 47 and speaker segments 42a-42c—may be supplied as a stand-alone item or kit and subsequently connected to a separately sourced video display 20.

Referring to FIG. 4, audio system 13 is depicted and comprises speaker segments 42a-42c attached to adjustable speaker mounting system 47. The speaker segments 42a-42c may be supplied in an unattached condition along with adjustable speaker mounting system 47 and then subsequently attached to their respective speaker engagement support panels 48a-48c such as by screws or other mechanical fasteners. In one example, speaker segments 42a-42c are manufactured with respective on-board motors (not shown) that rotate respective pinion gears 62a-62c (not shown in FIG. 4). Magnet 54 (or multiple magnets) may be pre-attached to video display engagement support panel 53 or provided in an unattached condition and then subsequently attached to either upper speaker engagement surface 28 of video display 20 or video display engagement support panel 53 lower surface 57. In some examples, support shelf 36 may also be provided and fixedly attached to upper speaker engagement surface 28 by via screws or other mechanical fasteners. In that case, magnet 54 (or a plurality thereof) may be attached to lower surface 57 of video display engagement support panel 53 as described previously.

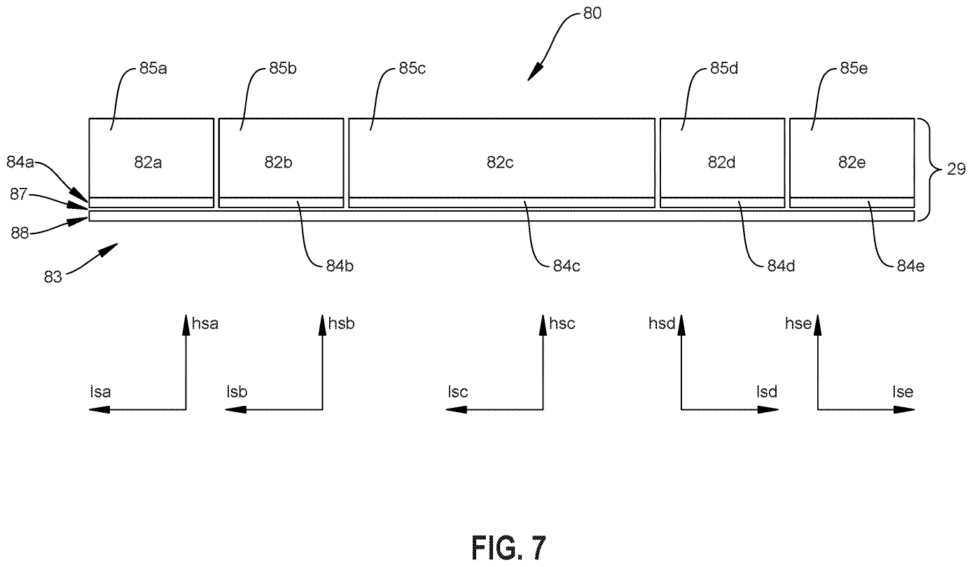

Referring again to FIGS. 4-5C, if support shelf 36 is not provided, magnet 54 (or plurality thereof) must generate a sufficient magnetic force to resist the force of gravity on the audio system 13 along the video display height axis h_{d}. In one example wherein soundbar 40 comprises three speaker segments 42a-42c that collectively weigh about ten (10) lbs., four (4) one inch square magnets are provided per speaker segment 42a-42c, each magnet having a magnetic field of about 2,060 gauss. Thus, for each soundbar segment 42a-42c, the magnets are associated with that segment are collectively sufficient to provide a magnetic force by weight of the speaker segment 42 a-42c that is no less than 750 gauss/lb, preferably no less than 800 gauss/lb., and still more preferably, no less than 820 gauss/lb. If support shelf 36 is provided, the required magnetic field strength per unit weight of audio system 13 is about one half of what it is required without the support shelf. As will be discussed in greater detail relative to the embodiments of FIGS. 7-10B, the speaker drivers 46a-46c may be rotatable about an axis that is perpendicular to a plane defined by their respective length axis lₛₐ, l_{sb}, and: l_{sc} and respective thickness axis tₛₐ, t_{sb}, and t_{sc}, so that specific audio content can be directed laterally relative to a viewer/listener.

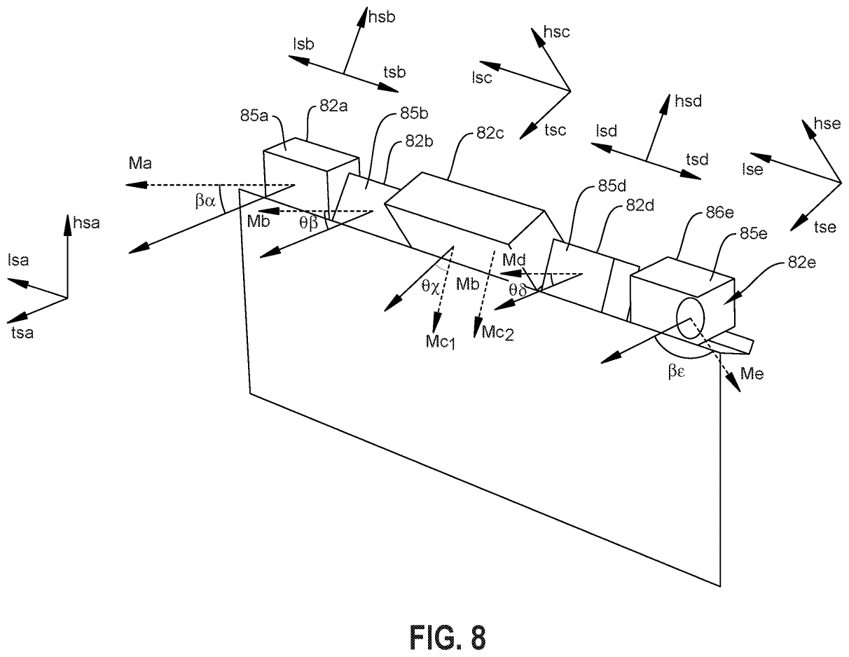

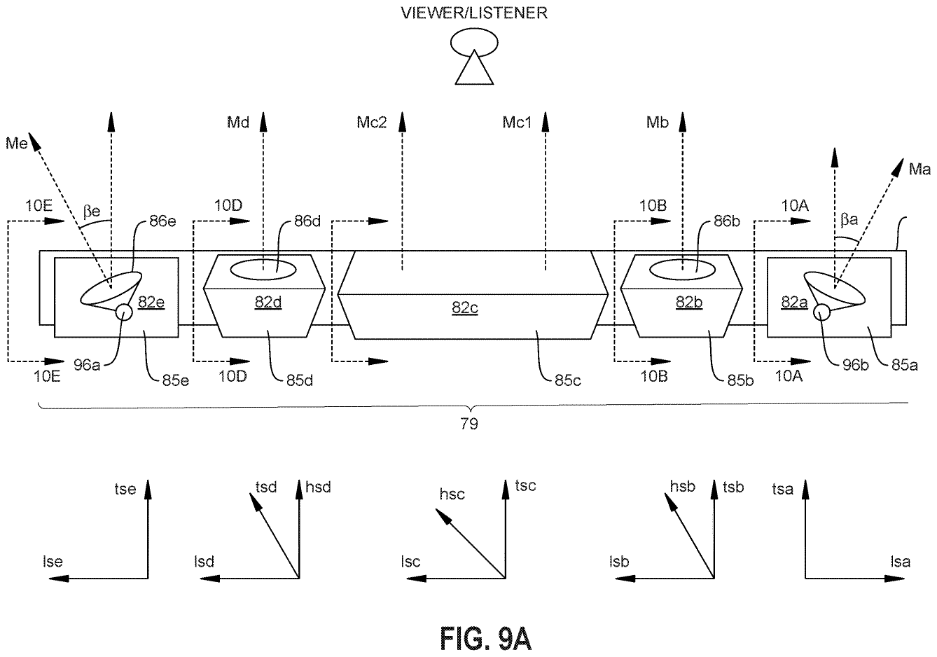

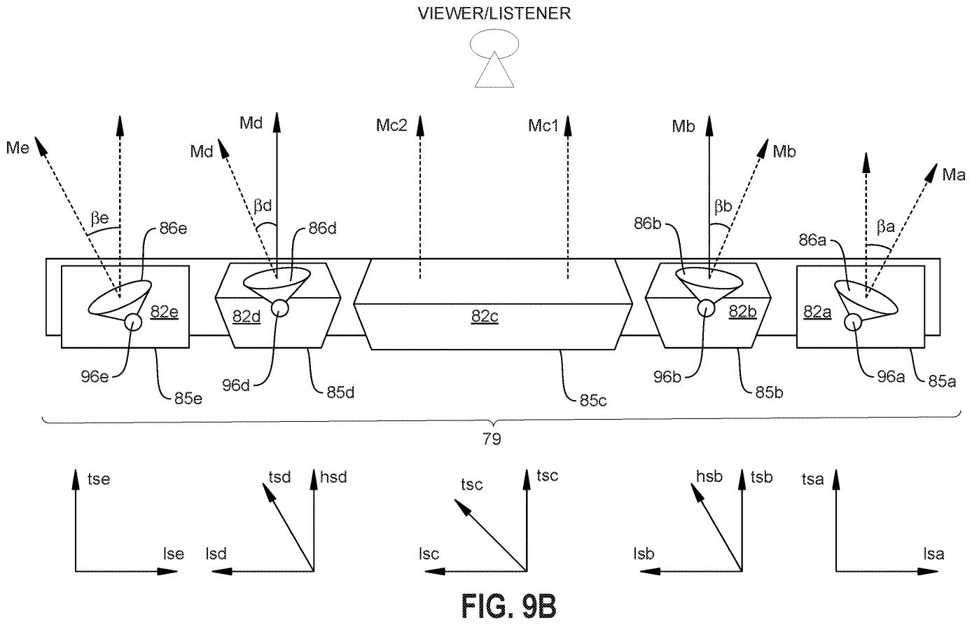

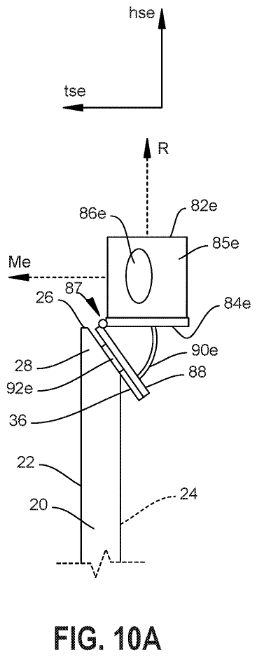

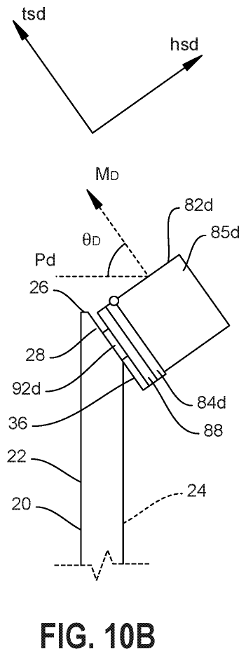

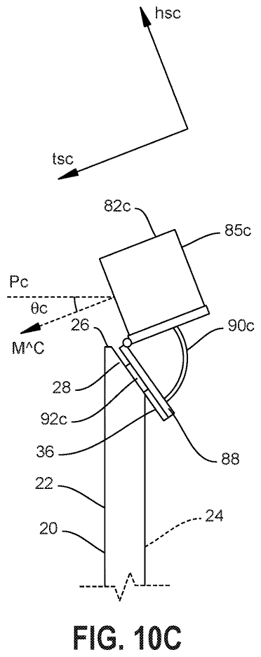

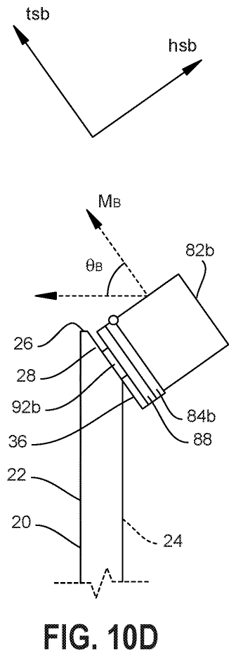

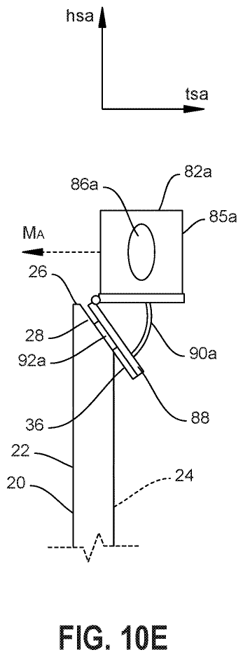

Referring to FIGS. 7-10E, an embodiment of an audio system 79 is described. Audio system 79 comprises multi-segment soundbar 80 and adjustable speaker mounting system 83. Multi-segment soundbar 80 comprises speaker segments 82a-82c, each of which has a corresponding housing 85a-85e, and each of which houses at least one corresponding speaker driver. In FIGS. 7-10B, speaker segments 82a, 82b, 82d, and 82e each have one driver, 86a, 86b, 86d, or 86e, and speaker 82c has two speaker drivers 86c₁ and 86c₂. In FIG. 7 audio system 79 is viewed from a front plan view (i.e., along the speaker segment thickness axes tₛₐ, t_{sb}, and t_{sc}) and is shown in an assembled condition in which it is uninstalled on video display 20 and. Each driver median axis Ma, Mb, Mc₁, Mc₂, Md, and Me (FIGS. 9A-9B) is perpendicular to the page. In FIG. 8 the speaker segments 82 a-82e are shown in a first rotational orientation about a rotational axis R defined by hinge 87 although the adjustable speaker mounting system 83 is not shown in FIG. 8 itself. The same rotational orientation of speaker segments 82a-82e is shown in FIGS. 9A, 9B and 10A-10E.

Adjustable speaker mounting system 83 comprises a video display engagement member 88 which is attached via hinge 87 (or a plurality thereof) to a plurality of speaker engagement support panels 84a-84e, each of which corresponds to one of the speaker segments 82a-82e. The audio system 79 is attachable to video display 20 in a similar fashion to audio visual system 12 albeit with two more speaker segments 82a and 82e and two more corresponding speaker engagement support panels 84a and 84f. Support shelf 36 may also be used with audio system 79 and attached in the same manner to as described previously relative to FIGS. 3A-5C. Alternatively, groups of speaker segments 82a-82f may have a support shelf or each individual speaker segment 82a-82f may have a support shelf. The audio system 79 may be magnetically attached to an upper speaker engagement surface 28 of a video display 20 or to an upper surface 51 of support shelf 36, which is then fixedly attached to upper speaker engagement surface 28 of video display 20 and magnetically attached to multi-segment soundbar 80 in the manner described previously.

In the embodiment of FIGS. 7-10E, each speaker segment 82a-82e may be characterized by its own length, height, and thickness axes. The axes are not fixed in space, but rather, are fixed spatially relative to their respective speaker segment 82a-82e. Thus, speaker segment 82a has a length axis lₛₐ, a height axis hₛₐ, and a thickness axis tₛₐ. Corresponding axes are defined for each other speaker segment. Each speaker segment 82a-82e is rotatable about an axis parallel to the video display width axis w_{d}. As depicted in the figures, hinge 87 defines an axis of rotation that is parallel to the video display width axis w_{d}, and each speaker engagement support panel 84a-84e may rotate independently about hinge 87, either manually or automatically, in the manner described previously with respect to the embodiment of FIGS. 4-5C. Although not separately shown, in FIGS. 7-10B, similar motor and gear structures, such as the rack gears 60a-60c (60c being shown) and pinion gears 62a-62c (62c being shown) may be used (as may the different variants thereof) in order to rotate each speaker support panel 84a-84e and its corresponding speaker segment 82a-82e. In addition, each driver 86a-86e (86c not show) may rotate about an axis parallel to its speaker segment's height axis. This can best be seen in FIGS. 9A and 9B in which the soundbar 79 is viewed along the height axis h_{d} of the video display 20. Speaker driver 86a is rotatable about an axis defined by shaft 96a (which extends into the page) in a plane defined by its length lₛₐ and thickness tₛₐ axes. The other speaker drivers 86a-86e are similarly rotatable in a plane defined by their respective length and thickness axes, i.e., l_{sb}/t_{sb}, l_{sc}/t_{sc}, l_{sd}/t_{sd}, lₛₑ/tₛₑ and about an axis defined by a respective shaft 96a, 96b, 96c1 (not shown), 96c2 (not shown), 96d, and 96e. Thus, in certain examples each driver 86a-86e can be rotated relative to a plane defined by its height and thickness axes hₛₐ/tₛₐ, h_{sb}/t_{sb}, h_{sc}/t_{sc}, h_{sd}/t_{sd}, and hₛₑ/tₛₑ. The extent of any particular driver's rotation relative to its corresponding speaker segment's height/thickness plane may be characterized by an internal rotation angle β for that driver. When viewed from above, internal rotational angles βₐ-βₑ that are clockwise relative to the height/thickness plane have positive values and those that are counterclockwise relative to the height/thickness plane have negative values. For example, referring to FIGS. 9A-9B, when viewed from above, speaker driver 86a is rotated clockwise by an angle βₐ relative to a plane defined by its height axis hₛₐ and thickness axis tₛₐ plane about a rotational axis defined by shaft 96a. Thus, βₐ has a positive value. In contrast, speaker driver 86e is rotated counterclockwise by an angle βₑ relative to a plane defined by its height axis hₛₑ and thickness axis tₛₑ. Thus, βₑ has a negative value.

In FIG. 9A, speaker drivers 86b and 86d are not rotated relative to planes defined by their respective height and thickness axes h_{sb}/t_{sb} and h_{sd}/t_{sd}. Thus, β_{b} and β_{d} are zero. However, in FIG. 9B, speaker driver 86b is rotated about shaft 96b clockwise relative to a plane defined by its height axis h_{sb} and its thickness axis t_{sb}, and therefore, β_{b} has a positive value. Also, in FIG. 9B, speaker driver 86d is rotated counterclockwise (due to the rotation of shaft 96d) relative to a plane defined by its height axis h_{sd} and its thickness axis t_{sd}. Therefore, β_{d} has a negative value. In preferred examples, the values of β for each speaker segment 82a-82e range from at least −15 degrees to at least +15 degrees, preferably from at least −45 degrees to at least +45 degrees, and more preferably from at least −90 degrees to at least +90 degrees. Suitable motors are preferably provided within the housing 85a-85e of each speaker segment 82a-82e to rotate the shaft 96a, 96b, 96c₁, 96c₂, 96d, and 96e corresponding to each driver 86a, 86b, 86c1, 86c2, 86d, and 86e.

One benefit of having the various degrees of freedom for the speaker drivers 86a-86e is that during a sporting event, for example, center drivers 86c1, 86c2 can be oriented straight at the viewer/listeners for maximum clarity of an announcer's voice, while drivers 86a and 86e may each be tilted away from center drivers 86c1, 86c2 and toward the walls, creating a stadium-like effect, even when ordinary TV stereo is used in the absence of surround sound. Directing the left and right front speakers away for the viewers during sporting events and similar announcer-centric programming further enhances clarity of the announcer by the announcer's audio having to compete less with the sounds of the event. In other situations involving, for example, upfiring audio content, such as Dolby ATMOS, the drivers 86a-86e may be selectively tilted relative to a horizontal plane depending on whether such content is or is not being played.

In FIGS. 10A-10E, views are provided of each specific speaker segment 82a-82e in soundbar 80 while in the rotational orientation about hinge 87 that is shown in FIGS. 8 and 9A. Note that each speaker segment 82-82e or groups thereof is attached so a speaker support shelf 36. Each speaker segment 82a-82e is attached to the speaker support shelf 36 via a respective magnet or respective set of magnets 92a, 92b, 92c, 92d, and 92e. In certain examples the magnets have the magnetic field strength per pound of weight described above with respect to FIGS. 5A-5C and 6.

Rack gears 90a, 90b (not shown), 90c, 90d (not shown), and 90e and pinion gears 92a, 92b, 92c, 92d, and 92e (not shown but structured and operate like pinion gears 62a-62c) in this embodiment would be understood to be similar to those in FIGS. 5A-5C but are removed for ease of viewing. Thus, FIG. 10A shows speaker segment 82a while looking along the video display width w_{d} axis along line 10A-10A of FIGS. 9A-9B. As FIG. 10E indicates, speaker support panel 84a is rotated upward to an upfiring angle θₐ of about zero. As is also shown in FIGS. 9A and 9B, driver 86a is rotated within housing 85a about an axis of rotation R defined by shaft 96a to a negative value of the internal rotation angle βₐ. In FIG. 10A the upfiring angle θₑ of speaker segment 82e has the same value (0) as upfiring angle θₐ of speaker segment 82a. However, as shown in FIGS. 9A-B, as compared to driver 86a, driver 86e is rotated in the opposite direction relative to the plane defined by its height axis hₛₑ and thickness axis tₛₑ, such that βa and βe have similar magnitudes but opposite signs.

FIG. 10D shows a view of speaker segment 82 b taken along line 10B-10B in FIG. 9A. Speaker segment 82b is in its rest or unrotated state relative to the axis of rotation defined by hinge 87. Therefore, the upfiring angle θ_{b} is positive and about 45 degrees. In FIG. 9B driver 86 b is not internally rotated within housing 85b about the axis defined by shaft 96b, and therefore, has an internal rotation angle β_{b} with a value of zero. FIG. 10B shows speaker segment 82d which is oriented in the same way that speaker segment 82b and has the same upfiring (θ) and internal rotation (β) angles.

FIG. 10C shows a view of speaker segment 82 c taken along line 10C-10C of FIGS. 9A-9B. Speaker engagement support panel 84e is rotated upward about a rotation axis defined by hinge 87 such that median axes Mc₁ and Mc₂ are angled downward relative to horizontal plane P, and thus, their upfiring angles θ_{c1} and θ_{c2} have equal negative values. The drivers 86_{c1} and 86_{c2} are not visible in FIGS. 10C or 9A-9B. However, their median axes Mc₁ and Mc₂ are. As they indicate the drivers 86_{c1} and 86_{c2} are not rotated internally relative to housing 85_{c}, and therefore, β_{c1} and β_{c2} have values of zero.

The values of the internal rotation angles βa, βb, βc₁, βc₂, βd, and βe may be adjusted manually in certain embodiments or may be adjusted automatically in the same or other embodiments. A local controller on the audio system 79 and/or a remote control may be used to enter a desired internal rotational angle. Additionally, or alternatively, a controller or controllers in the audio system 79 may be provided to adjust the internal rotational angles based on values encoded into the audio signals provided to each channel that is operatively connected to each speaker segment 82a-82e. For example, particular audio content may include sounds intended to be heard from the left and the right of the viewer/listener, in which case, the audio stream for channels operatively connected to speaker segments 82a and 82e may encode suitable values of βa and βe which may be adjusted by a rotational orientation controller based on data regarding the room geometry and/or viewer/listener location. In some examples, a viewer/listener may also enter room geometry information and information about his/he location which may be used to adjust the value of the internal rotation angle that is encoded not the audio stream for each channel.

As disclosed, these are some examples of useful embodiments of the invention. The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

1. An audio visual system, comprising:
a video display having a video display housing, the video display housing having an upper surface and a lower surface spaced apart along a video display height axis; and
an audio system, comprising:
a speaker comprising at least one speaker driver in a speaker housing, the speaker housing having a lower surface, the at least one speaker driver having a median axis, wherein the lower surface of the speaker housing is magnetically attached to the upper surface of the video display such that a non-orthogonal angle is defined between the median axis and a horizontal plane.

2. The audio visual system of claim 1, wherein the speaker comprises at least two speaker drivers, each of the at least two speaker drivers receiving different audio content from at least one audio content source.

3. The audio visual system of claim 2, wherein the at least two speaker drivers are automatically rotatable about respective median axes of the at least two speaker drivers.

4. The audio visual system of claim 1, wherein the speaker driver is operable to project sound in an upward direction along a median axis relative to the horizontal plane.

5. The audio visual system of claim 1, wherein the video display upper surface is sloped relative to the horizontal plane to define an angle between the video display upper surface and the horizontal plane which is equal to the non-orthogonal angle.

6. The audio visual system of claim 1, wherein the speaker comprises a soundbar, the speaker housing is a soundbar housing having a length along a soundbar length axis, and the at least one speaker driver is at least two speaker drivers spaced apart from one another along the soundbar length axis.

7. An audio visual system, comprising:
a video display having an upper surface and a lower surface; and
an adjustable speaker mounting system magnetically attached to a video display surface selected from among the upper surface and the lower surface of the video display, the adjustable speaker mounting system having a speaker engagement support that is rotatable relative to the selected video display surface.

8. The audio visual system of claim 7, further comprising an audio system, the audio system including the adjustable speaker mounting system and a speaker, the speaker comprising at least one speaker driver disposed in a speaker housing, wherein the speaker housing is attached to the speaker engagement support.

9. The audio visual system of claim 7, wherein the speaker engagement support is attached to a video display engagement support, and the speaker engagement support is rotatable relative to the video display selected surface.

10. The audio visual system of claim 9, wherein a rotational position of the speaker engagement support relative to the selected video display surface is automatically adjusted based on whether the speaker is playing upfiring audio content.

11. The audio visual system of claim 7, wherein the speaker comprises a first speaker comprising the at least one speaker driver disposed in a first speaker housing and a second speaker comprising a second speaker driver disposed in a second speaker housing, wherein the first speaker housing is spaced apart from the second speaker housing along a width axis of the video display, the speaker engagement support is a first speaker engagement support, the adjustable mounting system further comprises a second speaker engagement support that is rotatable relative to the video display selected surface, the first speaker housing is attached to the first speaker engagement support, and the second speaker housing is attached to the second speaker engagement support.

12. The audio visual system of claim 11, wherein the adjustable speaker mounting system further comprises a video display engagement support that is attached to the first and second speaker engagement supports and magnetically attached to the video display selected surface.

13. The audio visual system of claim 12, wherein the adjustable speaker mounting system comprises a first gear attached to the speaker engagement support and rotatable about an axis of rotation that is fixed in space relative to the speaker engagement support, the adjustable speaker mounting system further comprising a second gear having a first end attached to the video display engagement support and a second end extending through a plane defined by the speaker engagement support, wherein the first gear engages the second gear such that rotation of the first gear causes the first gear to travel along the second gear and thereby adjust a rotational position of the speaker engagement support relative to the video display engagement support.

14. The audio visual system of claim 7, further comprising an audio system comprising a speaker that includes at least one speaker driver disposed in a speaker housing, wherein the speaker housing is rotatable relative to the video display selected surface about a first axis parallel to a width axis of the video display and the at least one speaker driver is rotatable relative to the speaker housing about a second axis perpendicular to the first axis.

15. The audio visual system of claim 7, wherein the video display upper surface is sloped relative to a horizontal plane, the audio visual system further comprises a support shelf attached to the video display upper surface and having a rear retaining wall that retains the adjustable speaker mounting system, and the adjustable speaker mounting system is magnetically attached to the support shelf.

16. A speaker system comprising:
an audio system comprising a speaker comprising at least one speaker driver disposed in a speaker housing;
an adjustable speaker mounting system comprising a first member hingedly connected to a second member such that the first and second members are rotatable relative to one another about an axis of rotation, wherein the speaker housing is removably attachable to the first member such that when the speaker housing is attached to the first member, an angle defined between a median axis of the at least one speaker driver and a plane parallel to the second member can be adjusted by rotating the first member relative to the second member.

17. The adjustable speaker system of claim 16, wherein the second of the two hinged members is magnetic or has a magnet attached to it.

18. The adjustable speaker system of claim 16, wherein the adjustable speaker mounting system comprises a third member hingedly connected to the second member, wherein the speaker comprises a first speaker, the at least one speaker driver comprises a first at least one speaker driver, and the speaker housing comprises a first speaker housing, and the audio system further comprises a second speaker comprising a second at least one speaker driver disposed in a second speaker housing, wherein the second speaker housing is removably attachable to the third member such that when the second speaker housing is attached to the third member, an angle defined between a median axis of the second speaker and the second member can be adjusted by rotating the third member relative to the second member.

19. The adjustable speaker system of claim 16, wherein the audio system comprises a motor disposed in the speaker housing and which is operable to rotate the first member relative to the second member, wherein the motor is operatively connected to a first gear, the adjustable speaker system further comprising a second gear attached to the second member and engageable with the first gear such that when the first gear is engaged with the second gear, rotation of the first gear causes the first member to rotate relative to the second member.

20. The adjustable speaker system of claim 16, wherein the at least one speaker driver is rotatable within the housing and relative to the housing.
